(19) United States
(12) Patent Application Publication
(10) Pub. No.: US 2026/0055350 A1
(43) Pub. Date: Feb. 26, 2026

(54) METHOD FOR PRODUCING A HOP EXTRACT EMULSION, HOP EXTRACT EMULSION PRODUCED HEREWITH, FOOD AND CORRESPONDING USES

(71) Applicant: SIMON H. STEINER, HOPFEN, GMBH, Mainburg (DE)

(72) Inventor: Frank PEIFER, Mainburg (DE)

(21) Appl. No.: 19/100,256

(22) PCT Filed: Jul. 12, 2023
(86) PCT No.: PCT/EP2023/069274

§ 371 Date: Jan. 31, 2025

(30) Foreign Application Priority Data
Aug. 4, 2022 (DE) 10 2022 119 594.5

(51) Int. Cl. C12C 3/08; B01F 23/50; B01F 31/80; B01F 101/15; C12C 3/10; C12C 5/02; C12C 7/28

(52) U.S. Cl. CPC C12C 3/08; B01F 23/551; B01F 31/89; C12C 3/10; C12C 5/02; C12C 5/026; C12C 7/287; B01F 2101/15; B01F 2215/0454; B01F 2215/0477

(57) ABSTRACT

A process for preparing a hop extract emulsion, at least comprising the steps of: Providing a hop extract, mixing the hop extract with water, wherein the mass ratio of water to hop extract is from 40:60 to 95:5 (water:hop extract), and homogenizing the resulting mixture using ultrasound, resulting in the hop extract emulsion; and the hop extract emulsion prepared according to the invention, beverages and foodstuffs prepared thereby, and corresponding uses.

### CROSS-REFERENCE TO RELATED APPLICATIONS

The present application is a National Stage Entry of International Application Number PCT/EP2023/069274, filed Jul. 12, 2023, which claims the benefit of German Application Number 102022119594.5, filed Aug. 4, 2022, the disclosures of which are hereby incorporated by reference in their entireties.

### TECHNICAL AREA

The invention relates to a process for preparing a hop extract emulsion according to claim 1, a hop extract emulsion prepared thereby according to claim 11, a foodstuff prepared thereby or a precursor thereof according to claim 13, and the uses according to claims 14 to 18.

### PRIOR ART

Hops and hop products made from them have a wide range of applications, the vast majority of which are found in beer production. From a sensory point of view, the bitter and aroma characteristics of hops describe the intended use of hops and the hop products made from them. For both of the above-mentioned applications, hop products exist that are used both in the hot process area of the brewhouse and in the cold process area of the cellar or filtration. For some years now, hop-flavored beers have been in increasing demand. This development has resulted in the need to provide brewers with products that are as user-friendly as possible, with optimum availability of the aroma substances. However, in the case of conventional aroma-rich hop extracts or corresponding emulsions, segregation and separation of these products into two or more phases have been repeatedly observed during storage, which is why the storage stability of such products is still a problem.

### OBJECT OF THE INVENTION

Consequently, it is an object of the present invention to provide a process which allows the preparation of a hop extract emulsion which does not visibly segregate when stored for several months at 5 to 10° C., i.e., which does not show any phase separation visible to the eye despite storage for several months at 5 to 10° C. It is further an object of the present invention to provide a corresponding hop extract emulsion. It is further an object of the present invention to provide a food product prepared with the hop extract emulsion or a precursor therefor and corresponding uses.

### Definitions

In the context of the present invention, the term “α-acids” includes non-isomerized and isomerized α-acids.

In the context of the present invention, “storage stable” or “long-term storage stable” is understood to mean the property of an emulsion according to which, when the emulsion is stored at a temperature between 5 and 10° C., no segregation of the latter occurs with the formation of two phases which would be visible to the eye, for a period of at least 12 months from the time of preparation of the homogeneous emulsion.

### SUMMARY OF THE INVENTION

The above-mentioned task is solved by the subject-matter of the independent claims. Advantageous embodiments of the present invention are the subject-matter of the dependent claims.

In terms of the process, the object is solved by the process according to claim 1. Thus, a process for the preparation of a hop extract emulsion is claimed, at least comprising the steps:
(k) providing a hop extract, preferably a CO₂ extract or an ethanol extract or a mixture of a CO₂ extract and an ethanol extract;
(l) mixing the hop extract with water, wherein the mass ratio of water to hop extract is from 40:60 to 95:5 (water:hop extract), preferably 40:60 to 90:10, in particular 50:50 to 70:30; and
(m) homogenizing or emulsifying the mixture resulting from step (1) using ultrasound, i.e., introducing ultrasound into the mixture, resulting in the hop extract emulsion.

In the process according to the invention, it can optionally be provided that solids which may be present and are not emulsifiable are separated from the hop extract emulsion according to the invention before storage or use. Particularly advantageously, the separation of the non-emulsifiable solids can be carried out after cooling the hop extract emulsion to a temperature between 0 and <5° C.

The hop extract emulsion according to the invention resulting from step (m) of the process according to the invention is surprisingly stable over a long period of time, namely at least 12 months, when stored at a temperature between 5 and 10° C., in the sense that no segregation of the homogeneous emulsion occurs with the formation of two phases which would be visible to the eye. This property is also referred to below as “storage stable” or “long-term storage stable”.

Furthermore, the hop extract emulsion according to the invention obtained by the process according to the invention can be dissolved in hot wort or cold beer or water or other aqueous media without any problems and in high yield. As a result, the hop extract emulsion according to the invention can be used without problems in all areas of brewing, beverage production or in the production of other foodstuffs, in particular as an additive to precursors or to the final product of beverages and foodstuffs. This applies in particular when the aromatizing properties of hops are the object of the use.

Surprisingly, water, preferably drinking water, process water or brewing water, in particular demineralized brewing water, is sufficient for the production of the homogenized hop extract emulsion. No further material additives are required to achieve the homogeneity and the long-term storage stability of the hop extract emulsion described above. Therefore, according to the process according to the invention, it can be provided that the hop extract emulsion according to the invention is limited to the components water and hop extract and that no further material ingredients other than hop extract and water are used in the entire process for producing the hop extract emulsion.

In addition, when using the hop extract emulsion according to the invention, due to the fact that the starting material of the process according to the invention is a hop extract, little to no solid ballast, in particular hop trub, is introduced into the brewing process, which would have to be removed from the wort or beer at other points at great expense. This provides a further advantage, namely that the otherwise high loss of wort or beer (up to 30% beer loss in the cold process area is possible) can be effectively avoided during the separation of hop trub due to the excellent solubility of the hop extract suspension according to the invention.

The inventor also found that the mixture of hop extract and water can be homogenized or emulsified without any difficulty over the entire mass ratio range from 40:60 to 95:5 (water:hop extract) and that a storage-stable emulsion can be produced. If the mixture of hop extract and water consists of more than 60% hop extract, spontaneous or short-term segregation was observed, consequently, long-term storage stability in the sense of the invention is currently not achievable with more than 60% hop extract in the mixture (cf. also FIG. 5 and associated description). With a mass fraction of the hop extract of less than 10%, in particular less than 5%, the production of a homogeneous, storage-stable emulsion is technically possible, but economically not interesting with increasing water content.

A mass ratio range of 40:60 to 70:30 (water:hop extract) or 50:50 to 70:30 has proven to be particularly advantageous, representing a good compromise between homogenization capability, storage stability and economy.

The inventor further found that optimum homogenization results of the extract-water emulsion can be obtained if the homogenization is carried out only with ultrasonic input into the mixture. However, according to the process or method of the invention, it is not excluded that the ultrasonic input is assisted by stirring or pumping the emulsion, or by both. Accordingly, the process according to the invention may be limited in that only ultrasound or only ultrasound and stirring and/or pumping of the mixture is used for homogenization according to step (m). However, further measures to achieve or stabilize the homogeneous emulsion are not necessary and can be dispensed with.

As a result, a highly enriched liquid hop aroma product can be obtained by means of the process according to the invention as the hop extract emulsion according to the invention, which can be used directly and undiluted in all stages of beer or beverage production. The hop extract emulsion can be used without any prior treatment such as heating or stirring. The hop flavor yields are generally at least in the range of hop pellets, depending on the time of use and the process.

Advantageous embodiments of the process according to the invention are the subject-matter of the dependent claims.

Thus, in the process according to the invention, the hop extract of step (k) can be obtained by at least the following steps:
(a) Providing a hop product in the form of cone hops or hop pellets, preferably type 90 pellets;
(b) Producing an extract from the hop product, preferably producing a CO₂ extract from the hop product using supercritical CO₂ or producing an ethanol extract from the hop product using ethanol;
(c) at least partial separation of α-acids from the extract; and
(d) preferably at least partially separating β-acids from the extract; wherein step (d) is carried out before or after step (c), preferably after step (c). Here, the extract remaining after carrying out step (c) or (d) is the hop extract.

Processes for the production of a hop product in the form of cone hops or hop pellets leading to the hop products according to step (a) are the usual processes sufficiently known to the skilled person.

Processes for producing an extract from the hop product that can be used for step (b) or (k) of the process according to the invention are known to the skilled person, for example, from the reference book by Forster, Biendl, Schönberger “Hopfen—Vom Anbau bis zum Bier” (Hops From Cultivation to Beer), Fachverlag Hans Carl GmbH, 1^{st} edition, 2012, ISBN 978-3-418-00808-0, pages 135 to 160, the disclosure of which is incorporated by reference in its entirety.

The at least partial separation of α-acids from the extract according to step (c) can be carried out according to any method known to the skilled person, preferably according to the methods described in document US 2011/0 287 152 A1, the disclosure of which is incorporated by reference in its entirety.

Furthermore, in the process according to the invention, it may be provided that a partial or complete isomerization of the α-acids present in the extract takes place between steps (b) and (c), but this is not mandatory.

The options explained above show that the hop extract to be used for the process according to the invention can be obtained in a variety of ways and is not subject to any particular limitations. After separation of the majority of the α-acids, the proportion of remaining β-acids may become so high that at least partial separation of the β-acids is required to ensure homogenization. The inventor found that the higher the proportion of remaining β-acids, the more difficult it is to achieve complete homogenization in step (m). Therefore, especially when the proportion of remaining β-acids is high, it can be provided according to the invention to set a mass ratio of water to hop extract of greater than 50:50 and up to 90:10, preferably greater than 50:50 and up to 80:20, (water:hop extract) in step (1).

The at least partial separation of β-acids from the extract after step (d) can be carried out by any method known to the skilled person, preferably by the method described in the reference book by Forster, Biendl, Schönberger “Hopfen-Vom Anbau bis zum Bier” (Hops—From Cultivation to Beer), Fachverlag Hans Carl GmbH, 1st edition, 2012, ISBN 978-3-418-00808-0, page 176. The inventor observed that when the β-acids are separated according to this method, some of the α-acids still remaining in the extract are also separated.

According to the invention, it is preferred to separate a total of at least 90% by mass, preferably at least 99% by mass or even 100% by mass, of the α-acids from the extract in steps (c) and (d).

Further, the process may comprise the following step:
(e) separating the extract remaining after step (c) or (d) by distillation, the distillation residue obtained after carrying out step (e) being the hop extract.

By distilling the hop extract according to optional step (e), it is possible, if desired, to process a hop extract partially depleted in hop oils using the process according to the invention. The hop extract based on the distillation residue that can be obtained with this embodiment of the process according to the invention can also be homogenized in water, as provided according to the invention. Due to the depletion of hop oils, the resulting emulsion is preferably not used for beer aromatization. Surprisingly, this hop extract emulsion is excellent as a natural foam inhibitor. For example, the product can be added to the wort in the brewhouse to prevent excessive foaming of the wort during boiling. Furthermore, this product can also be added to the wort during fermentation to reduce or prevent foaming in the fermentation tank.

Furthermore, in the process according to the invention, the α-acids contained in the extract can be at least partially isomerized prior to step (c). This process step can be carried out according to any process known to the skilled person, preferably according to the process described in the reference book by Forster, Biendl, Schönberger “Hopfen—Vom Anbau bis zum Bier” (Hops—From Cultivation to Beer), Fachverlag Hans Carl GmbH, 1^{st} edition, 2012, ISBN 978-3-418-00808-0, page 174, the disclosure of which is incorporated by reference in its entirety.

Furthermore, the process according to the invention may be limited in that no other substance, preferably no other fluid, in particular no other solvent, other than water is brought into contact with the hop extract when carrying out steps (1) and (m) or during the entire process. Also, according to the invention, it is advantageously not necessary to use steam (water vapor) or other emulsification aids with the exception of ultrasound in the process according to the invention, so that the use of steam, for example to facilitate emulsification, can be excluded in the process according to the invention. In general, according to the invention, contact of the hop extract or the mixture of hop extract and water with steam can completely be avoided. This lowers the thermal load and thus the risk of a possible reduction in the quality of the hop extract or the mixture. Furthermore, the inventor found that the separation of a solid layer or of solid particles according to the optional steps (n) to (p) as described below is facilitated if the introduction of steam into the mixture during steps (1) and (m) is completely omitted.

Furthermore, in the process according to the invention, the power introduced into the mixture by ultrasound may be from 50 to 100 W/kg of the mixture.

The ultrasound used in homogenization according to the process of the invention may have a frequency of 16 to 40 kHz, preferably 18 to 30 KHz.

In the process according to the invention, the duration of homogenization may be from 0.5 to 20 minutes, preferably from 1 to 10 minutes.

The inventor of the present invention found that if one, two, preferably all of the above ranges are observed with respect to the power introduced into the mixture by ultrasound, the ultrasonic frequency and the duration of homogenization, optimum homogenization of the hop extract-water mixture and the long-term storage stability described above are achieved. If a power of less than 50 W/kg of the mixture is introduced, sufficient homogenization or long-term stability cannot be ensured. If, on the other hand, the power introduced is greater than 100 W/kg of the mixture, the mixture may heat up too much and there is a risk of thermally induced quality losses with regard to the hop constituents of the mixture. With respect to ultrasonic frequency, the inventor found that resonances occur within the claimed ranges, particularly around 20 kHz, which facilitate homogenization of the mixture. With respect to the duration of homogenization, in the experience of the inventor, sufficient homogenization cannot be reliably ensured for a duration shorter than 1 minute, in particular shorter than 0.5 minutes. Technologically, there is no upper limit to the duration of homogenization, but a limitation to 20 minutes or even to 10 minutes has proven to be an optimum compromise in terms of complete homogenization on the one hand and short process duration and low energy or heat input on the other. Also from the point of view of oxygen input into the mixture, a shorter homogenization time, i.e. 20 minutes or shorter, preferably 10 minutes or shorter, is preferred.

Furthermore, the process according to the invention may be limited in that the hop extract and the mixture of the hop extract and water each do not exceed a temperature of 70° C., preferably 60° C., preferably 58° C., in particular 50° C., or even fall below these temperatures. Alternatively or in addition thereto, the process according to the invention can be limited in that heating of the hop extract or the mixture of the hop extract and water to a temperature above 70° C., preferably above 60° C., preferably above 58° C., in particular above 50° C., is omitted.

The limitation of the temperature to which the hop extract and/or the mixture are exposed advantageously serves to avoid quality losses due to negative thermal influence and to maintain the high quality of the hop extract. Thus, the inventor recognized that the process according to the invention allows the mixture to be homogenized without any problems even at higher temperatures of greater than 50° C., such as 55° C., 58° C. or 60° C., however, at temperatures of greater than 50° C. or, in particular, greater than 60° C., the homogenization effect is no longer improved, but from these temperatures onwards an increased evaporation of value-giving aroma substances, such as hop oils, from the mixture to be homogenized can be observed, which, depending on the object, may be undesirable and should therefore be avoided. In any case, the inventor observed in experiments that as long as the temperature of the mixture does not exceed 50° C. during homogenization, there is virtually no influence on the contents of the value-giving hop aroma oils, such as myrcene, linalool, caryophyllene and humulene (measured by method EBC 7.12), in the mixture. Thus, yields of aroma substances (hop oils) of >95% could be achieved in the homogenization mixture.

Therefore, in the process according to the invention, it can preferably also be provided that the water has a temperature of 5 to 30° C., preferably 10 to 20° C., when mixed with the hop extract in step (1). This measure can advantageously contribute to keeping the temperature of the mixture or hop extract emulsion in step (m) at a temperature of below 60° C., preferably below 50° C., i.e., as low as possible, despite the energy input by the ultrasound.

Finally, the process according to the invention may be limited in that it further comprises the following steps:
(n) cooling the homogenized mixture obtained from step (m) to a temperature between 0 and <5° C.;
(o) maintaining the temperature of the mixture between 0 and <5° C. for at least 24 hours; and
(p) skimming from the mixture a layer of solids or particles of solids formed on the surface of the mixture during step (n) or (o).

The further embodiment of the process according to the invention in accordance with process steps (n), (o) and (p) makes it possible to separate hop waxes and other poorly soluble constituents, which may not be desired in the hop extract emulsion according to the invention and are initially homogenized by the process according to the invention together with the other constituents of the mixture, completely and in a simple manner from the homogenized mixture as a floating solid layer. In this process, no further segregation of the homogenized hop extract emulsion takes place, i.e., the other components of the mixture remain stable as an emulsion.

The above-mentioned object is further solved by a hop extract emulsion prepared by the process according to the invention as described above. In this context, the advantages discussed above in connection with the process according to the invention apply directly or at least analogously to the hop extract emulsion according to the invention.

The hop extract emulsion according to the invention has a water content of 40 to 95% by mass, preferably 40 to 90% by mass, in particular 50 to 70% by mass.

Furthermore, the hop extract emulsion according to the invention is characterized by a low viscosity, namely 5 to 150 mPa·s, preferably 10 to 100 mPa's, in particular 20 to 50 mPa's, measured at 20° C., shear rate of 120 l/s and according to DIN 53019, 2008-09 edition. Surprisingly, the low viscosity of the hop extract emulsion according to the invention also remains essentially stable over the entire storage period and changes only insignificantly (max. increase: 15%, based on the initial viscosity after completion of homogenization, during storage over 12 months at a temperature between 5 and 10° C.).

In contrast, conventional hop extracts (concentrates) have a significantly higher viscosity of at least 200, in particular at least 300 mPa·s, measured at 50° C., shear rate of 120 l/s and according to DIN 53019, 2008-09 edition. At temperatures below 50° C., these are then partially solid, i.e. insoluble. Due to the lower viscosity of the hop extract emulsion according to the invention compared to these conventional hop extracts, there is a wide range of applications of the hop extract emulsion according to the invention in the hot process area and, in particular, in the cold process area of the brewery or another food manufacturer. Thus, due to the low viscosity of the hop extract emulsion according to the invention, solubility in wort, beer or other foodstuffs or their precursors is improved, and in particular, dissolution in a cold medium is only possible, i.e., at a temperature of the medium between 0 and 25° C. Based on the experience of the inventor, major problems arise with the conventional hop extracts described above with regard to dissolving them, especially in cold media, such as cold wort or beer.

Details of the determination of viscosity as carried out within the scope of the present invention: The measurement was carried out with a Rheomat R120 (rotational viscometer), manufacturer: proRheo GmbH, Althengstett/Germany, according to DIN 53019, edition 2008-09. The measurement was carried out with a defined measuring body (No. 3 with a diameter of 14 mm) and a measuring tube (No. 3 with a diameter of 18 mm). For measurement, the measuring body was immersed in a heatable water bath. The water bath and thus the measuring body were heated to a temperature of 20° C. or 50° C., depending on the hop extract, and the viscosity was read on the rotational viscometer at a shear rate of 120 l/s. The result is given in mPa's (millipascalseconds), indicating the measuring temperature (here: 20° C. or 50° C.) and the shear rate (here: 120 l/s).

In a preferred embodiment of the hop extract emulsion according to the invention, the sum of the mass fractions of hop extract and water is at least 95%, preferably at least 98%, preferably at least 99%, in particular at least 99.5%, based on the total mass of the hop extract emulsion. In an even more preferred embodiment, the hop extract emulsion according to the invention consists of the hop extract and water.

In a preferred embodiment of the hop extract emulsion according to the invention, the hop extract emulsion does not show any segregation into two phases visible to the naked eye within 12 months from production when the hop extract emulsion is stored at a temperature of 5 to 10° C.

The object of the invention is further solved by a foodstuff or a precursor thereof, preferably a beverage, in particular a wort or a beer, which contains the hop extract emulsion according to the invention or was produced using the hop extract emulsion according to the invention.

Again, the advantages discussed above, in connection with the process according to the invention, apply directly or at least analogously to the foodstuff, preferably beverage, in particular beer, produced with the hop extract emulsion according to the invention.

The object of the invention is also solved by the uses according to the invention.

Thus, according to the invention, the use of ultrasound to prepare a hop extract emulsion is claimed, wherein the hop extract emulsion comprises or consists of a hop extract and water. More specifically, this also includes the use of ultrasound to emulsify a mixture comprising or consisting of hop extract and water.

Any limitations of the process according to the invention, the hop extract (production and/or pretreatment) or the hop extract emulsion as discussed herein may also be used, individually or in any combination, to limit the uses according to the invention. In particular, the use according to the invention according to any one of claims 14 to 18 may be further specified with one or more of the following optional features in any combination:
the mass ratio of water to hop extract is 40:60 to 95:5 (water:hop extract), preferably 40:60 to 90:10, in particular 50:50 to 80:20 or 50:50 to 70:30;
the water has a temperature of 5 to 30° C., preferably 10 to 20° C., when mixed with the hop extract in step (1);
when ultrasound is used to produce the hop extract emulsion, the mixture forming the hop extract emulsion consists of the hop extract and water, with no other additives or emulsifying aids, including steam, being added to the mixture;
the hop extract is prepared from a hop product according to steps (a) to (d) or (a) to (e) described above, wherein prior to step (c) the α-acids contained in the extract are not, partially or completely isomerized;
the hop extract emulsion consists of the hop extract and water;
the power introduced by ultrasound into the mixture of hop extract and water is from 50 to 100 W/kg of the mixture;
the ultrasound has a frequency of 16 to 40 kHz, preferably 18 to 30 kHz;
the duration of ultrasound exposure is 0.5 to 20 minutes, preferably 1 to 10 minutes;
during the ultrasonic treatment, the hop extract and/or the mixture of the hop extract and water does not exceed a temperature of 70° C., preferably 60° C., in particular 50° C., in each case;
during the ultrasonic treatment, the hop extract or the mixture of hop extract and water is not heated to a temperature above 70° C., preferably above 60° C., especially above 50° C., respectively.

According to the invention, the use of ultrasound results in the formation of a homogeneous hop extract emulsion which is stable over a long term. Due to the relatively low energy input and the associated low temperature rise during the input, the use of ultrasound is particularly gentle on the product and in particular on the aroma, i.e., it is associated with a low loss of aroma due to evaporation or thermal degradation. Moreover, the advantages discussed above for the process according to the invention and the hop extract emulsion according to the invention also apply analogously to the use according to the invention.

Furthermore, the use of the hop extract emulsion according to the invention is claimed as an additive to a foodstuff or a precursor thereof, preferably to a beverage, in particular to a wort or a beer. This includes in particular the use of the hop extract emulsion according to the invention, prepared from a hop extract at least partially depleted in α-acids, β-acids and hop oils, as a defoaming agent for wort, beer or other liquid foods or precursors thereof.

The inventor recognized that the addition of the hop extract emulsion according to the invention or prepared according to the invention to the wort before, during or after treatment of the wort in the whirlpool, preferably between knocking-out or casting the wort out of the brew kettle and cooling the wort in the wort cooler, is particularly advantageous. For example, the inventor found that when the hop extract emulsion of the invention is added to the wort in the whirlpool, the yield of individual hop oil components can be increased up to 95%. In contrast, the yields of these hop oil components were only about 50% when hop pellets type 90 were used analogously in the whirlpool, although the same overall oil contents were added to the wort in both approaches (cf. Table 3 below).

In addition, the hop extract emulsion according to the invention or produced according to the invention can be added to the wort or beer at one or more points in the cold process area of the brewery, i.e., from the pitching with the yeast to the filling of the finished beer into the containers intended for distribution. In this way, valuable hop constituents, especially the hop oil components, can be transferred to the beer in particularly high yields (cf. Table 4 below).

The addition of the hop extract emulsion of the invention to the wort or beer during the main fermentation has proven to be particularly advantageous. Thus, the hop extract emulsion can preferably be added at the beginning of the main fermentation, i.e. between the pitching of the wort with the yeast and the end of the second fermentation day, preferably during the first 24 hours after pitching.

Surprisingly, it was also found that the yield of hop oil components, especially of esters, in the finished beer can be increased when using the hop extract emulsion according to the invention as described in this document. This allows the fruity character of the resulting beers to be specifically enhanced and emphasized. Thus, according to the invention, the use of the hop extract emulsion according to the invention can also be provided for increasing the yield of hop oil components and/or esters in the finished beer.

Finally, the use of the hop extract emulsion according to the invention as a defoaming agent is claimed. With the hop extract emulsion according to the invention, an excellent defoaming effect can be achieved for foodstuffs of all kinds or a precursor thereof which tend to foam, but also for a variety of other substances, such as products or precursors from chemical, pharmaceutical, pertrochemical, microbiological production. This is especially true if the hop extract emulsion was prepared from a hop extract that was at least partially depleted in α-acids, β-acids and hop oils.

In all other respects, the advantages discussed above for the process according to the invention and the hop extract emulsion according to the invention also apply analogously to the uses according to the invention.

The inventor further found the following advantages of the invention described herein:
When using the hop extract emulsion according to the invention, there is no introduction of vegetative material of the hops into the beverage or other foodstuff or into a precursor thereof. In addition, there is virtually no introduction of nitrate into the beverage or other foodstuff or into a precursor thereof. Furthermore, no particles are introduced into the end product, such as a beer or other beverage, which would require elaborate or time-consuming removal. Furthermore, the beer losses that conventionally occur can be avoided by separating particles and hop trub during cold hopping. Finally, when the hop extract emulsion according to the invention is used in the brewhouse (addition of the hop extract emulsion according to the invention to the wort), a smaller amount of hop trub occurs in the whirlpool, which facilitates separation and minimizes beer losses. Finally, the hop extract emulsion according to the invention can be used in a simple way, e.g. by automated dosage in a closed system.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 shows the state of the mixture of hop extract and water prior to, and after, homogenization.

FIG. 2 shows the state of the mixture of hop extract and water before, and after, homogenization.

FIG. 3 shows the state of the mixture of hop extract and water before, and during various stages of, homogenization.

FIG. 4 shows a foam retarding effect.

FIG. 5 shows the result of homogenization after ultrasonic treatment.

### EXAMPLES

The following ultrasound equipment was used in all approaches A to D described below:
Manufacturer: Bandelin, 12207 Berlin
Type: Sonoplus HD 4400;
Ultrasonic generator GM4400—400 watts;
TS 425 titanium sonotrode
Working frequency: 20 kHz;

### Approach A: Preparation of Homogenized Aroma Extract

A hop extract was prepared by conventional means by extraction with CO₂ or ethanol. After isomerization and separation of the α-acids from the hop extract, a large part of the β-acids was also separated from the hop extract by a conventional method (variant A1).

In an alternative variant (variant A2), a hop extract was prepared by conventional means by extraction with CO₂ or ethanol. After separation of the non-isomerized α-acids from the hop extract, a large proportion of the β-acids were also separated from the hop extract by a conventional method.

The resulting hop extract of variants A1 and A2, here also referred to as aroma extract, contains only an insignificant proportion of bittering hop acids, in particular only a maximum of ⅓ to ½ of the original β-acid concentration. Depending on the hop variety used, the hop extract has a high to very high content of hop oils (15 to 45% by mass).

In the test batch, the viscous hop extract of variant A1 obtained as described above was mixed with water in a mass ratio of 50:50. The resulting mixture was homogenized with the above-mentioned ultrasonic device for 5 minutes at an amplitude of 100% and without pulsation at room temperature (400 watts; 20 kHz). The mixture was not cooled during homogenization. Self-heating of the mixture to about 50° C. was measured during homogenization.

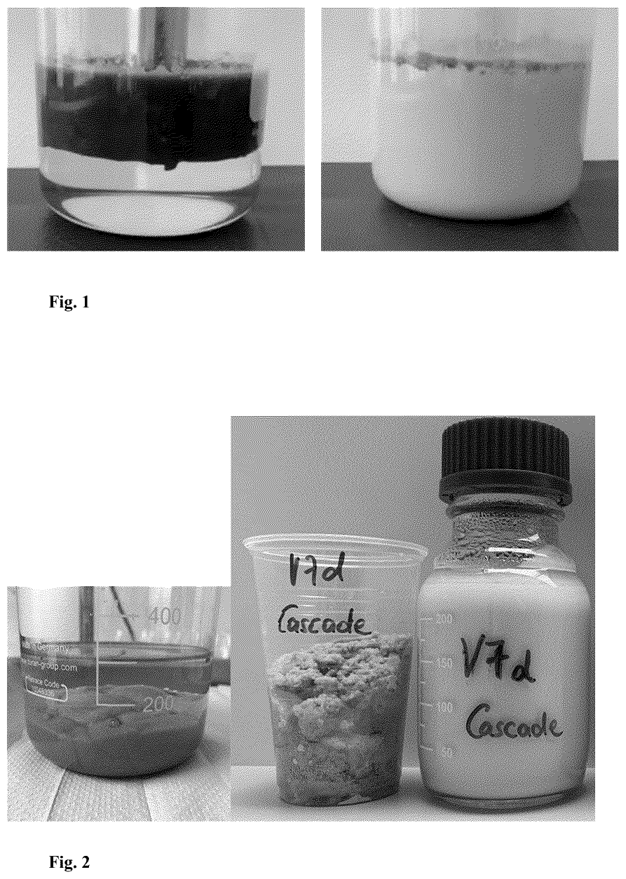

FIG. 1 shows on the left the state of the mixture of hop extract and water prior to homogenization by the process according to the invention (batch A, variant A1). The mixture of hop extract (top; dark brown) and water (bottom) is clearly recognizable as a two-phase system. In the right half of FIG. 1, the state after carrying out the homogenization according to the invention by means of ultrasound under the above-mentioned conditions is shown. A single, homogeneous phase in light beige color can be seen, which has flow properties similar to water. Precipitated waxes, which can be seen floating on the surface, could be removed by simple skimming after cooling to a temperature between 0 to <5° C. In the hop extract emulsion, the yield of aroma substances (hop oils) was >95% (cf. Tab. 1 below).

In the case of the hop extract emulsion prepared in this way according to the invention, no segregation of the hop extract emulsion into two phases was observed even after 12 months of storage at a temperature between 5 and 10° C., for example at 6° C.

TABLE 1
Approach A

| | Hop | Hop extract |
|---|---|---|
| | extract | emulsion |
| Total oil* ml/100 g | 31.5 | 15.9 |
| Myrcene** % rel. | 20.6 | 19.1 |
| Linalool** % rel. | 0.7 | 0.7 |
| Caryophyllene ** % rel. | 23.3 | 23.7 |
| Humulene** % rel. | 36.5 | 38.1 |

*measured according to EBC 7.10
**measured according to EBC 7.12, based on total oil

As can be seen from Table 1, the content of the total oil in the hop extract emulsion according to the invention was reduced in this approach compared with the hop extract used due to the admixture of the water in accordance with the mixing ratio. Advantageously, the homogenization according to the process of the invention had virtually no influence on the relative contents of the hop aroma oils myrcene, linalool, caryophyllene and humulene which give value (based on total oil, measured by method EBC 7.12).

The process according to the invention in the embodiment of approach A described above yields a highly enriched, liquid hop extract emulsion for direct and undiluted administration into, for example, wort or beer during beer production.

### Approach B: Preparation of Homogenized Beta Extract

A hop extract was prepared by conventional method by extraction with CO₂ or ethanol. After isomerization, the α-acids were separated from the hop extract using a conventional method. The β-acids were left in the hop extract (variant B1).

In an alternative variant (variant B2), a hop extract was prepared by conventional means by extraction with CO₂ or ethanol. The α-acids were separated from the hop extract without pre-isomerization using a conventional method. The β-acids were left in the hop extract.

The resulting hop extract (variants B1 and B2), also called beta extract here, contains only an insignificant proportion of bittering hop acids, but still has approximately the original β-acid concentration. Depending on the hop variety used, the hop extract has a medium to high content of hop oils. Depending on the hop variety used, the hop extract can be hard and solid or highly viscous, depending on the ambient temperature.

In the test batch, the hop extract of variant B1 obtained as described above was mixed with water in a mass ratio of 50:50. The resulting mixture was homogenized with the above-mentioned ultrasonic device for 5 minutes at an amplitude of 100% and without pulsation at room temperature (400 watts; 20 kHz). The mixture was not cooled during homogenization. Self-heating of the mixture to about 50° C. was measured during homogenization.

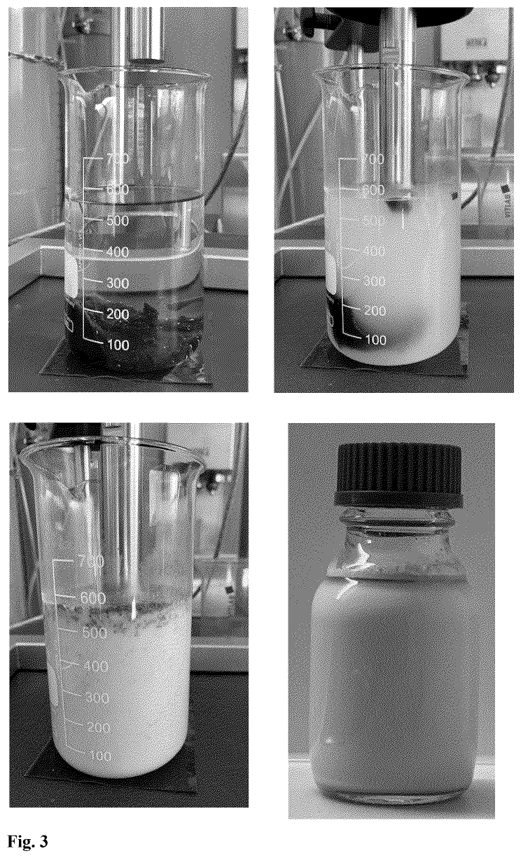

FIG. 2 shows on the left the state of the mixture of hop extract and water before homogenization according to the process of the invention as described in approach B, variant B1. The mixture of hop extract (bottom; brown) and water (top) is clearly recognizable as a two-phase system. In the right half of FIG. 2 (bottle), the state of the mixture after carrying out the homogenization according to the invention by ultrasound under the above conditions and after separation of hard, insoluble lumps with high concentration of β-acids precipitated during homogenization is shown. A single homogeneous phase of light beige color can be seen, which has flow properties similar to water.

The precipitated, light brown lumps are shown in a beaker in the center of FIG. 2. In addition, waxes that were present floating on the surface after cooling to a temperature between 0 to <5° C. could be removed by simple skimming. In the hop extract emulsion, the yield of aroma substances (hop oils) was <80% (cf. Tab. 2 below).

In the case of the hop extract emulsion according to the invention prepared in this way, no segregation of the hop extract emulsion into two phases was observed even after 12 months of storage at a temperature between 5 and 10° C., for example at 6° C.

TABLE 2
Approach B

| | Hop | Hop extract |
|---|---|---|
| | extract | emulsion |
| Iso-α-acids* % | 1.2 | 0.7 |
| α-acids* % | <0.1 | <0.1 |
| β-acids* % | 54.2 | 15.3 |
| Total oil** ml/100 g | 9.6 | 3.7 |
| Myrcene*** % rel. | 13.9 | 15.1 |
| Linalool*** % rel. | 0.5 | 0.8 |
| Caryophyllene*** % rel. | 11.0 | 8.0 |
| Humulene*** % rel. | 26.0 | 22.5 |
| Farnesene*** % rel. | 3.0 | 1.7 |

*measured according to EBC 7.8
**measured according to EBC 7.10
***measured according to EBC 7.12, based on total oil

As can be seen from Table 2, the content of total oil in the hop extract emulsion according to the invention decreased compared to the hop extract used also in batch B, variant B1, due to the admixture of water. Furthermore, it was observed that the content of β-acids in the homogenized hop extract emulsion was greatly reduced due to the precipitation of solids. The inventor suspects that hop oils, especially the poorly soluble components caryophyllene and humulene, also adhere to the precipitated solid to a small extent. In contrast, the relative contents of the value-giving hop aroma oils myrcene, linalool, caryophyllene and humulene were approximately unchanged after homogenization. The inventor attributes the slight differences in the relative contents of the hop aroma oils after emulsification compared to the initial state to the reduced hop oil content due to adhesion to the solid.

The process according to the invention in the form of the above-described approach B yields a medium-enriched, liquid hop extract emulsion for direct and undiluted addition to, for example, wort or beer during beer production. In addition, a solid hop product rich in β-acids could be produced as a by-product in the same approach for further utilization.

### Approach C: Preparation of Homogenized, De-Oiled Aroma Extract

A hop extract was prepared by conventional method by extraction with CO₂ or ethanol. After isomerization, the α-acids were separated from the hop extract by a conventional method. Most of the β-acids were removed from the hop extract by conventional means. Furthermore, 50 to 80% of the hop oil content was separated from the hop extract by distillation (variant C1).

In an alternative variant (variant C2), a hop extract was prepared by conventional means by extraction with CO₂ or ethanol. The α-acids were separated from the hop extract without pre-isomerization using a conventional method. Most of the β-acids were removed from the hop extract by conventional methods. Furthermore, 50 to 80% of the hop oil content was separated from the hop extract by distillation.

The resulting hop extract (variants C1 and C2), here also referred to as de-oiled aroma extract, contains only an insignificant proportion of bittering hop acids and only a maximum of ⅓ to ½ of the original β-acid concentration. Depending on the hop variety used, the hop extract has a very low to low content of hop oils. Depending on the hop variety used, the hop extract can be pasty or semi-solid, depending on the ambient temperature.

In the test batch, the hop extract of variant C1 obtained as described above was mixed with water in a mass ratio of 500:30 (water:hop extract). The resulting mixture was homogenized with the above-mentioned ultrasonic device for 5 minutes at an amplitude of 100% and without pulsation at room temperature (400 watts; 20 kHz). The mixture was not cooled during homogenization. Self-heating of the mixture to about 50° C. was measured during homogenization.

In FIG. 3, the state of the mixture of hop extract and water before homogenization according to the process of the invention is shown in the upper left-hand corner according to approach C, variant C1. Here, the mixture of hop extract (bottom; dark brown) and water (top) is clearly recognizable as a two-phase system. FIG. 3, top right, shows the state of the mixture after 2 minutes of homogenization, bottom left after 5 minutes of homogenization (i.e., after completion of the ultrasonic treatment). In this test batch, it can be seen that an ultrasonic treatment of 2 minutes is not yet sufficient to achieve a homogeneous emulsion. After completion of the homogenization step, non-emulsifiable solids and waxes that were present floating on the surface after cooling to a temperature between 0 to <5° C. could be removed by simple skimming. The homogenized hop extract emulsion, freed from the remaining solids, is shown in the bottled state in FIG. 3, bottom right. A single, homogeneous phase of light beige color can be seen, which exhibits flow properties similar to water.

In the case of the hop extract emulsion prepared in this way according to the invention, no segregation of the hop extract emulsion into two phases was observed even after 12 months of storage at a temperature between 5 and 10° C., for example at 6° C.

The process according to the invention in the embodiment of approach C described above yields a hop extract emulsion for direct and undiluted administration into e.g., wort or beer during beer production, which is highly effective especially for reducing the foaming of the boiling or fermenting wort.

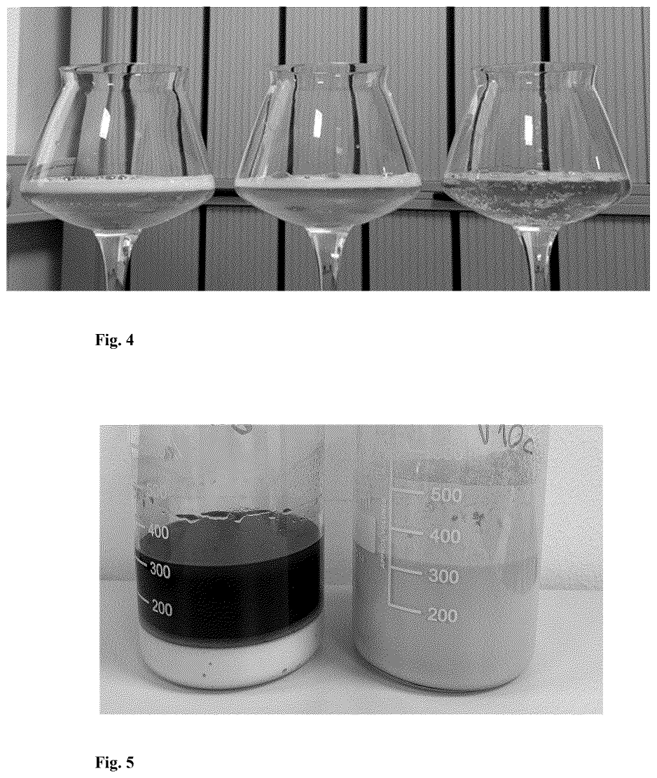

The foam retarding effect is shown in FIG. 4. In FIG. 4, the glass on the left contains a beer without addition of the hop extract emulsion according to batch C, variant C1 (control), the glass in the middle contains the same beer to which 5 g/hl of the hop extract emulsion according to batch C, variant C1, has been added, and the glass on the right contains the same beer to which 10 g/hl of the hop extract emulsion according to batch C, variant C1, has been added. The picture was taken 25 seconds after the simultaneous addition of the hop extract emulsion. As can be seen from FIG. 4, the amount of foam decreases as the amount of hop extract emulsion added increases, with a clear decrease in the head of the beer already being observed at an addition of 5 g/hl and especially at an addition of 10 g/hl.

Approach D: Variation of the Mixing Ratio in the Homogenized Aroma Extract from Batch A.

In another batch, batch D, the mass-related mixing ratio of water to hop extract was varied: 40:60 and 30:70 (water:extract). All other settings and characteristics are identical to the above described batch A, variant A1.

FIG. 5 shows the result of the homogenization test after 5 minutes of ultrasonic treatment: the beaker in the right half of the picture contains the preparation according to the invention with a mixing ratio of 40:60 (water:extract), which resulted in a homogeneous and storage-stable hop extract emulsion (homogeneous phase with light beige color).

The beaker in the left half of the picture, on the other hand, contains the preparation not according to the invention with a mixing ratio of 30:70 (water:extract), which apart from the different mixing ratio was prepared in exactly the same way. In this batch, spontaneous segregation and the formation of two clearly recognizable phases occurred immediately after the end of the ultrasonic treatment (top: dark brown extract phase; bottom: light beige liquid phase). It was thus not possible to produce a homogeneous hop extract emulsion for this mixing ratio.

A further approach, Approach E, was used to test which yields of hop aroma components can be achieved in a wort when various hop products are added to the wort during its treatment in the whirlpool. For this purpose, the hop extract emulsion according to the invention was added to the wort in the whirlpool at the beginning of the filling of the whirlpool. Similarly, hops were added to the wort in the form of type 90 pellets and in the form of a hop extract, as also provided in step (k) of the process of the invention for preparing the hop extract emulsion according to the invention, under the same conditions as for the batch according to the invention. Here, the addition was done in all three approaches in such a way that the same total amount of hop oils (g/hl) was added to the wort in each case. All three hop products used for this approach were produced from the same hop variety. The concentrations of the aroma components (terpenes, esters, terpene alcohols and ketones) in the respective chilled wort (chilled wort, after 50% of the volume of the wort batch was chilled (=Kühlmittewürze)) were determined by GC-MS using the in-house method of Hallertauer Hopfenveredelungsgesellschaft m.b.H., method “HHV 46-Aromastoffe in Bier”. The results are summarized in Table 3 below.

TABLE 3
Concentration of aroma components in the chilled wort when pellets
type 90, hop extract and hop extract emulsion according to
the invention are added to the wort in the whirlpool *

| Concentration of the | Pellet | | Hop |
|---|---|---|---|
| components in the | type | Hop | extract |
| chilled wort**. | 90 | extract | emulsion |

μg/L

| | | | |
|---|---|---|---|
| Myrcene | 1268 | 969.7 | 14100 |
| beta-Caryophyllene | 14.8 | 653.5 | 5609 |
| Humulene | 34.1 | 831.3 | 6695 |
| beta-limonene | 21.9 | 18.1 | 262.7 |
| Terpinolene | n.n. | n.n. | 13.3 |
| Isobutyl isobutyrate | 7.5 | <5 | 29.4 |
| 3-methylbutylisobutyrate | 31.4 | 11.6 | 89.3 |
| 2-Methyl butyl- | 59.8 | 65.5 | 459.8 |
| isobutyrate | | | |
| Methylgeranate | 62.4 | 90.6 | 647.3 |
| Geranyl acetate | n.n. | n.n. | 24.2 |
| Methyl nonanoate | n.n. | n.n. | 12.1 |
| Linalool | 97.3 | 71.7 | 164.3 |
| Geraniol | 104.7 | 50.3 | 89.4 |
| Terpineol | n.n. | 15.2 | 25.0 |
| Citronellol | n.n. | n.n. | 4.6 |
| 2-Undecanon | n.n. | 5.1 | 36.3 |
| 6-Methyl-5-hepten-2-on | 5.4 | n.n. | 8.0 |

n.n. = not determinable
* = Addition of hop products based on the total amount of hop oils measured according to EBC 7.10: The same amounts of hop oil (g/hl) from the same hop variety were always given in the product comparisons.
**= Determination of the concentration of the components by GC-MS according to the in-house method of Hallertauer Hopfenveredelungsgesellschaft m.b.H., method “HHV 46 - Aromastoffe in Bier”.

As can be seen from Table 3, the concentrations of hop aroma substances, i.e., terpenes, esters, terpene alcohols and ketones, are substantially increased in the batch in which the hop extract emulsion according to the invention was added to the wort compared with the batches in which either hop pellets or hop extract was added, and are usually many times higher. From this it can be concluded that the concentration of the hop aroma substances investigated in the wort can be significantly increased by adding the hop extract emulsion according to the invention compared to conventional hop products when added to the wort in the whirlpool under otherwise identical experimental conditions, and that the hop extract emulsion according to the invention exhibits good and rapid solubility in wort.

In a further approach, Approach F, tests were carried out to determine which yields of hop aroma components can be achieved in a ready-canned beer when various hop products are added to the fermenting wort. For this purpose, the hop extract emulsion according to the invention was added to the fermenting wort in the fermentation tank 24 hours after the wort had been pitched with yeast. Similarly, hops in the form of type 90 pellets were added to the fermenting wort under the same conditions as for the batch according to the invention. In both approaches, the hops were added in such a way that the same total quantity of hop oils (g/hl) was added to the wort. Beer produced in the same way, in particular from the same wort, but to which no hop product was added during fermentation (control), served here as a control. Also in this approach, the two hop products used were produced from the same hop variety. The concentrations of the aroma components (terpenes, esters, terpene alcohols and ketones) in the bottled beer were determined by GC-MS using the in-house method of Hallertauer Hopfenveredelungsgesellschaft m.b.H., method “HHV 46-Aromastoffe in Bier”. The results are summarized in Table 4 below.

TABLE 4
Concentration of aroma components in the bottled beer when pellets
type 90 and hop extract emulsion according to the invention
are added to the fermenting wort 24 hours with yeast*.

| Concentration of | untreated | Pellet | Hop |
|---|---|---|---|
| components in the | beer | type | extract |
| bottled beer (can)** | (control) | 90 | emulsion |

μg/L

| | | | |
|---|---|---|---|
| Myrcene | 19 | 68.7 | 123 |
| beta-Caryophyllene | n.n. | n.n. | <5 |
| Humulene | n.n. | <5 | 10 |
| beta-limonene | n.n. | 5.4 | 8.9 |
| Terpinolene | n.n. | 11.4 | 16.2 |
| Isobutyl isobutyrate | <5 | 12.8 | 24.7 |
| 3-methylbutylisobutyrate | <5 | 28.6 | 64.6 |
| 2-Methyl butyl- | 9.5 | 45.2 | 299.1 |
| isobutyrate | | | |
| Methylgeranate | n.n. | 76.5 | 290.6 |
| Geranyl acetate | n.n. | <5 | 6.4 |
| Nerol | n.n. | 28.7 | 41.9 |
| Linalool | 10.0 | 331.8 | 339.5 |
| Geraniol | 8.9 | 136.6 | 138.4 |
| Terpineol | 8.3 | 70.8 | 134.9 |
| Citronellol | 7.9 | 103.0 | 140.2 |
| 2-Undecanon | <5 | <5 | 5.7 |
| 6-Methyl-5-hepten-2-on | <5 | <5 | 6.0 |

n.n. = not determinable
*= Addition of hop products based on the total amount of hop oils measured according to EBC 7.10: The same amounts of hop oil (g/hl) from the same hop variety were always given in the product comparisons.
**= Determination of the concentration of the components by GC-MS according to the in-house method of Hallertauer Hopfenveredelungsgesellschaft m.b.H., method “HHV 46 - Aromastoffe in Bier”.

As can be seen from Table 4, the concentrations of hop aroma substances, i.e., terpenes, esters, terpene alcohols and ketones, in the finished beer can be significantly increased by the described cold hopping with conventional hop products such as Pellet Type 90 compared with the control beer without cold hopping. In the batch in which the hop extract emulsion according to the invention was added to the fermenting wort, even higher concentrations, up to a factor of 3 depending on the parameter, were obtained compared to the batch with Pellet Type 90, especially for the esters. In detail, the readily soluble terpene alcohols linalool and geraniol are present in almost equal concentrations in the pellet type 90 and the hop extract emulsion, as expected. In contrast, other terpene alcohols, such as nerol, citronellol and terpineol, which contribute floral and citrus notes to the beer aroma, are measured in increased concentrations in the resulting beer despite a similarly good solubility when using the hop extract emulsion according to the invention. The explanation for this phenomenon is most likely to be found in the so-called biotransformation of terpene alcohols and their precursor substances, which is described in this scientific publication: Takoi K, Koie K, Itoga Y, Katayama Y, Shimase M, Nakayama Y, Watari J. Biotransformation of hop-derived monoterpene alcohols by lager yeast and their contribution to the flavor of hopped beer, Journal of agricultural and food chemistry, 2010 Apr. 28; 58 (8): 5050-8, the disclosure of which is incorporated by reference in its entirety.

Similar observations can be made during cold hopping with conventional pellets, but not to such an extent as when using the hop extract emulsion according to the invention.

Furthermore, the esters show significantly higher values in the beer produced with the hop extract emulsion according to the invention. This resulted in a more intense fruit note and the clear preference of this beer from a sensory point of view.

The inventor made these observations regardless of the composition of the respective base wort in question.

From the above test results, it can be seen that the hop extract emulsion according to the invention is excellently suited for increasing the yield and/or concentration of hop oil components in the wort or beer.

1. A process for the preparation of a hop extract emulsion, comprising at least the steps:
(k) providing a hop extract, preferably a CO₂ extract or an ethanol extract or a mixture of a CO₂ extract and an ethanol extract;
(l) mixing the hop extract with water, wherein the mass ratio of water to hop extract is from 40:60 to 95:5 (water:hop extract), preferably 40:60 to 90:10, in particular 50:50 to 70:30; and
(m) homogenizing the mixture resulting from step (1) using ultrasound.

2. The process according to claim 1, wherein the hop extract of step (k) is obtained by at least the following steps:
(a) providing a hop product in the form of cone hops or hop pellets, preferably type 90 pellets;
(b) producing an extract from the hop product, preferably producing a CO₂ extract from the hop product using supercritical CO₂ or producing an ethanol extract from the hop product using ethanol;
(c) at least partial separation of α-acids from the extract; and
(d) preferably at least partially separating β-acids from the extract; wherein step (d) is performed before or after step (c), preferably after step (c),
wherein the extract remaining after carrying out step (c) or (d) is the hop extract.

3. The process according to claim 2, wherein the process further comprises the step of:
(e) separating the extract remaining after step (c) or (d) by distillation,
wherein the distillation residue obtained after carrying out step (e) is the hop extract.

4. The process according to claim 2, wherein before step (c) the α-acids contained in the extract are at least partially isomerized.

5. The process according to claim 1, wherein no other substance, preferably no other fluid, in particular no other solvent, other than water is brought into contact with the hop extract when carrying out step (1).

6. The process of claim 1, wherein the power introduced into the mixture by ultrasound is from 50 to 100 W/kg of the mixture.

7. The process according to claim 1, wherein the ultrasound has a frequency of 16 to 40 kHz, preferably 18 to 30 KHz.

8. The process according to claim 1, wherein the duration of homogenization is from 0.5 to 20 minutes, preferably from 1 to 10 minutes.

9. The process according to claim 1, wherein, when carrying out the process, the hop extract and the mixture of the hop extract and water each do not exceed a temperature of 70° C., preferably 60° C., in particular 50° C.

10. The process according to claim 1, the process further comprising the following steps:
(n) cooling the homogenized mixture obtained from step (m) to a temperature between 0 and <5° C.;
(o) maintaining the temperature of the mixture between 0 and <5° C. for at least 24 hours; and
(p) skimming from the mixture a layer of solids or particles of solids formed on the surface of the mixture during step (n) or (o).

11. A hop extract emulsion prepared by the process according to claim 1.

12. The hop extract emulsion according to claim 11, wherein the hop extract emulsion does not show any segregation into two phases visible to the eye within at least 12 months from production, when the hop extract emulsion is stored at a temperature of 5 to 10° C.

13. A foodstuff or a precursor thereof, preferably beverage, in particular wort or beer, containing the hop extract emulsion according to claim 11, or produced using the hop extract emulsion according to claim 11.

14. A use of ultrasound to prepare a hop extract emulsion containing or consisting of a hop extract and water.

15. The use of the hop extract emulsion according to claim 11 as an addition to a foodstuff or a precursor thereof, preferably to a beverage, in particular to a wort or a beer.

16. The use according to claim 15, wherein the hop extract emulsion is added to the wort before, during or after treatment of the wort in the whirlpool, preferably between knocking-out or casting the wort out of the brew kettle and cooling the wort in the wort cooler.

17. The use according to claim 15, to increase the yield and/or concentration of hop oil components in the wort or beer.

18. The use of the hop extract emulsion according to claim 11 as a defoaming agent.

19. The process according to claim 1, wherein there is no heating of the hop extract or the mixture of the hop extract and water to a temperature above 70° C., preferably above 60° C., in particular above 50° C.

20. The use according to claim 15, wherein the hop extract emulsion is added to the wort or beer in the cold process area of the brewery, preferably between the pitching of the wort and before the filtration or bottling of the beer, in particular at the start of fermentation.
